(19) United States
(12) Patent Application Publication
(10) Pub. No.: US 2011/0194295 A1
(43) Pub. Date: Aug. 11, 2011

(54) LIGHT REPOSITIONING OPTICS

(75) Inventors: John R. Householder, Reading, MA (US); Carlton S. Jones, Boxford, MA (US)

(73) Assignee: Fraen Corporation, Reading, MA (US)

(21) Appl. No.: 13/024,934

(22) Filed: Feb. 10, 2011

Related U.S. Application Data
(60) Provisional application No. 61/303,218, filed on Feb. 10, 2010.

(51) Int. Cl. F21V 7/08; F21V 7/04

(52) U.S. Cl. 362/347; 362/341

(57) ABSTRACT

Optical systems are disclosed herein for re-distributing light generated by a light source. For example, in one exemplary embodiment of the invention, the optic includes an optical body disposed about an optical axis. The optical body includes a proximal end and a distal end and a peripheral surface extending at least partially therebetween. An input surface disposed at the optical body's proximal end receives light from a light source. An optical redirecting element that is disposed at the optical body's distal end includes an output surface and a redirecting surface. The redirecting surface is configured such that substantially all light received from the peripheral surface undergoes total internal reflection and is thereby redirected out of the optical body at least partially through the output surface, e.g., perpendicular to the optical axis and/or in a proximal direction.

### CROSS-REFERENCE TO RELATED APPLICATIONS

The present application claims priority to a provisional application entitled “Light Repositioning Optics,” filed on Feb. 10, 2010 and having a Ser. No. 61/303,218. This provisional application is herein incorporated by reference in its entirety.

### FIELD OF THE INVENTION

The present patent application generally relates to optics and lighting systems.

### BACKGROUND OF THE INVENTION

Optics for high-power light sources, such as light emitting diodes, can have a wide variety of configurations. In many cases, a particular configuration can be characterized by the illumination pattern it produces, by the coherence, intensity, efficiency and uniformity of the light it projects, and/or in other ways. The application for which the optic and/or lighting system is designed may demand a high level of performance in many of these areas.

Accordingly, there is a need for improved optics and lighting systems.

### SUMMARY OF THE INVENTION

In one aspect, the present invention provides an optic that comprises an optical body disposed about an optical axis and having a proximal end and a distal end. The optical body includes an input surface that is disposed at the proximal end and is configured to receive light from a light source, and a peripheral surface that extends at least partially between the proximal and the distal ends. The optical body further includes an optical redirecting element that is disposed at the distal end. The input surface can form a cavity for receiving light from a light source, and the peripheral surface is configured such that light propagating thereto from the input surface undergoes total internal reflection and is thereby redirected to the redirecting element. The redirecting element includes an output surface and a redirecting surface that is configured such that substantially all light that it receives from the peripheral surface undergoes total internal reflection and is thereby redirected out of the optical body at least partially through the output surface, e.g., in a direction that is perpendicular to the optical axis and/or in a proximal direction. In some embodiments, the peripheral surface can be configured to image at least a portion of the light received through the input surface to a location adjacent the distal end of the optical body. In some embodiments, the redirecting surface is disposed about the optical axis. The redirecting surface can be, for example, symmetric or asymmetric about the optical axis.

In a related aspect, the redirecting surface can be configured such that at least about 80%, or at least about 85%, or at least about 90%, or at least about 95%, or 100% of the light that it receives from the peripheral surface would undergo total internal reflection at the redirecting surface and is thereby redirected out of the optical body at least partially through the output surface, e.g., perpendicular to the optical axis and/or in a proximal direction.

In another aspect, the redirecting surface can be configured such that at least about 80%, or at least about 85%, or at least about 90%, or at least about 95%, or 100% of the light that it receives directly from the input surface (i.e., the light that enters the optic through the input surface and traverses the optical body to reach the redirecting surface without encountering the peripheral surface) would undergo total internal reflection at the redirecting surface and is thereby redirected out of the optical body at least partially through the output surface, e.g., perpendicular to the optical axis and/or in a proximal direction. In one aspect, the redirecting surface can be configured such that substantially all of the light it receives directly from the input surface undergoes total internal reflection thereat.

In a related aspect, the redirecting surface can be configured to redirect light, e.g., via total internal reflection, out of the optical body through the output surface and the peripheral surface to a region proximal to a plane orthogonal to the optical axis and disposed at or near the distal end of the optical body and external thereto (“horizon plane”).

The optic can have a variety of forms. By way of non-limiting example, the peripheral surface of the optic can be ellipsoidal and/or the output surface can be disposed substantially parallel to the optical axis. In one aspect, the redirecting element can extend distally relative to a distal end of the peripheral surface. In a related aspect, the redirecting element can be in the form of a cylinder having a proximal end and a distal end. In some embodiments, the redirecting element can include a cylindrical output surface that extends from a proximal end to a distal end, and a redirecting surface. In some implementations, the redirecting surface can be concave when viewed externally, e.g., it can be in the form of an inverted cone wherein the vortex of the cone is disposed proximal to the distal end of the cylindrical output surface.

In one aspect, the optic can include an output annulus extending between the output surface and the peripheral surface. The output annulus can be configured to redirect, e.g., via total internal reflection, light incident thereon and propagating from the peripheral surface. By way of non-limiting example, the output annulus can be disposed substantially orthogonal to the optical axis.

In another aspect, an optic is disclosed that comprises an optical body that is disposed about an optical axis and includes a proximal end and a distal end. The optical body includes an input surface disposed at the proximal end and configured to receive light from a light source, and a peripheral surface that extends at least partway between the proximal and the distal ends. The optical body further includes a redirecting optical element that is disposed at the distal end. The input surface can include a cavity for receiving light from the light source, and the peripheral surface can be configured such that light propagating thereto from the input surface undergoes total internal reflection and is thereby redirected to the redirecting element. The redirecting element includes an output surface and a redirecting surface. In some embodiments, the redirecting surface can be disposed symmetrically about the optical axis, while in other embodiments, it can be asymmetrically disposed about the optical axis. The redirecting surface is configured to cause total internal reflection such that substantially all light that the redirecting surface receives from the peripheral surface undergoes total internal reflection and is thereby redirected out of the optical body at least partially through the output surface and to a region proximal to a plane orthogonal to the optical axis and disposed at or near the distal end of the optical body and external thereto (“horizon plane”).

In a related aspect, the redirecting surface can be configured such that at least about 80%, or at least about 85%, or at least about 90%, or at least about 95%, or 100% of the light that it receives from the peripheral surface undergoes total internal reflection thereat and is thereby redirected out of the optical body at least partially through the output surface to the region proximal to the horizon plane.

In one aspect, in the above optic, the redirecting surface can be configured such that substantially all light propagating thereto directly from the input surface undergoes total internal reflection and is thereby redirected out of the optical body and to the region proximal to the horizon plane. In one aspect, at least about 80%, at least about 85%, at least about 90%, at least about 95%, or 100% of such light propagating to the redirecting surface directly from the input surface undergoes total internal reflection and is thereby redirected out of the optical body and to the region proximal to the horizon plane.

In a related aspect, the redirecting surface can be configured to redirect light, e.g., via total internal reflection, out of the optical body to a region proximal to the horizon plane and through one or more of the output surface and the peripheral surface. In one aspect, the optical body is configured to couple substantially all source light incident on the input surface to the external environment and to a region proximal to the horizon plane. In one aspect, the optical body is configured to couple at least about 80 percent (or at least 85%, or at least 90%, or at least 95%, or 100%) of source light entering the optic through the input surface to the external environment and to a region proximal to the horizon plane.

The above optic can have a variety of forms. By way of non-limiting example, the peripheral surface can be ellipsoidal and/or the output surface can be disposed substantially parallel to the optical axis. In some embodiments, the peripheral surface can be configured to image the light source to a location adjacent the distal end of the optical body. In one aspect, the redirecting element can extend distally relative to a distal end of the peripheral surface. For example, in some embodiments, the redirecting element can be in the form of a cylinder having a proximal end and a distal end. In some embodiments, the redirecting element can include a cylindrical output surface that extends from a proximal end to a distal end, and a redirecting surface. In some implementations, the redirecting surface can be concave when viewed externally. For example, the distal surface of the cylindrical output element can form the redirecting surface. In some implementations, the redirecting surface can be in the form of an inverted cone wherein the vortex of the cone is disposed proximal to the distal end of the cylindrical output surface.

In one aspect, the above optic includes an output annulus extending between the output surface and the peripheral surface. The output annulus can be configured to redirect, e.g., via total internal reflection, light propagating from the peripheral surface that is incident thereon. By way of non-limiting example, the output annulus can be disposed substantially orthogonal to the optical axis.

In one aspect, a light pipe is provided that includes a proximal end, a distal end, and a lateral surface extending therebetween. The proximal end of the light pipe is configured to receive light generated by a light source (e.g., an LED). The lateral surface of the light pipe is configured to transmit light received from the proximal end, e.g., via total internal reflection, to an output surface disposed at the distal end of the light pipe. The distal end of the light pipe is configured to redirect substantially all light received from the lateral surface out of the light pipe at least partially through the output surface in a direction perpendicular to an optical axis of the light pipe and/or towards the proximal end. In some embodiments, the lateral surface can be configured to image the light source to a location adjacent the distal end of the light pipe.

In another aspect, an optic is disclosed that includes a compound elliptical concentrator extending along an optical axis between a proximal end a distal end. The compound concentrator is configured to receive light from a light source disposed at the proximal end and to output the light at the distal end. A redirecting element is optically coupled to the compound elliptical concentrator and includes an output surface that extends from the compound elliptical concentrator to a redirecting surface disposed about the optical axis. The redirecting surface is configured such that substantially all light propagating thereto from the compound elliptical concentrator undergoes total internal reflection and is thereby redirected out of the optical body in a direction perpendicular to the optical axis and/or in a proximal direction.

In a related aspect, the compound elliptical concentrator comprises a solid optical body with an elliptical peripheral surface configured such that light propagating thereto from the input surface undergoes total internal reflection and is thereby redirected to the redirecting element.

The above optic can also have a variety of configurations as otherwise discussed herein. For example, the output surface can be disposed substantially parallel to the optical axis. In another aspect, the redirecting surface can be substantially in the shape of an inverted cone. In one aspect, the compound elliptical concentrator can be configured to image at least a portion of the light received from the light source at the proximal end to a location adjacent the distal end of the compound elliptical concentrator.

In another aspect, an optic is provided that includes an optical body disposed about an optical axis and characterized by an anterior surface adapted for receiving light from a light source, a posterior surface, and a lateral surface extending at least partially between the anterior and posterior surfaces. The anterior surface forms a recess in the optical body with a central portion and a peripheral portion. The central portion of the anterior surface refracts light received from the light source to the posterior surface and the peripheral portion of the anterior surface refracts light received from the light source to the lateral surface. Further, the posterior surface is configured to cause total internal reflection of the light it receives from the central portion of the anterior surface so as to reflect that light, or at least a portion thereof, out of the optical body through the lateral surface.

The above optic can have a variety of configurations. For example, the recess can comprise a substantially rectangular recess, with the central portion presenting a distal wall to the light source and the peripheral portion comprising a sidewall. In a related aspect, the lateral surface can refract light received from the posterior surface and/or received from the sidewall of the recess. In one aspect, the posterior surface can totally internally reflect light received from the central portion to the lateral surface. In one aspect, the posterior surface totally internally reflects substantially all light received from the central portion of the recess. For example, the posterior surface totally internally reflects about 95% or more of light received from central portion of the recess so that light will exit the optic through at least a portion of the lateral surface.

In one aspect, in the above optic, the posterior surface is substantially in the shape of a inverted cone. In a related aspect, the posterior surface presents a substantially concave surface to an external environment. In addition or in the alternative, the posterior surface can include a plurality of surface features formed thereon which include any of surface texturing, microlenses, microprisms, lenslets, microcylinders, among others. Such surface features can additionally be included on any surface of the optics described herein, e.g., on the output surface.

In a related aspect, in the above optic, the optical body can be configured to couple substantially all source light incident on the anterior surface to the external environment perpendicular to the optical axis and/or in a proximal direction. In one aspect, the optical body is configured to couple at least about 80 percent (or at least 85%, or at least 90%, or at least 95%, or 100%) of source light incident on the anterior surface to the external environment perpendicular to the optical axis and/or in a proximal direction.

In another aspect, an optic is provided that includes an optical body disposed about an optical axis and characterized by an input surface disposed at the proximal end and configured to receive light from a light source, an output surface disposed at the distal end, and a peripheral surface extending at least partially between the proximal and the distal ends. The input surface forms a cavity for receiving light from at least one light source, and the peripheral surface is configured such that light propagating thereto from the input surface undergoes total internal reflection and is thereby redirected to the output surface.

In one aspect, in the above optic, the peripheral surface is elliptical. In a related aspect, the input surface can be disposed at or near one focal point of the elliptical peripheral surface and the output surface can be disposed at the other focal point. In one aspect, the output surface can be configured to reimage the light source to the output surface.

In one aspect, an optic is provided that includes an input surface adapted to receive light from a light source. The optic further includes an output surface through which the light exits the optical body. A peripheral surface, extending between the input surface and the output surface, is adapted to image at least a portion of the light received through the input surface onto the output surface.

In another aspect, an optic is provided that includes a compound elliptical concentrator extending along an optical axis between proximal and distal ends. The compound elliptical concentrator is configured to receive light from a light source via an input surface at the proximal end and to direct that light to an output surface at the distal end, through which the light can exit the optic. Further, the compound elliptical concentrator comprises a solid optical body with an elliptical peripheral surface configured such that light propagating thereto from the input surface undergoes total internal reflection and is thereby redirected to the output surface. In a related aspect, the compound elliptical concentrator is configured such that a light source can be disposed at or near one focal point of the compound elliptical concentrator and the output surface of the optic is located at or near another focal point of the compound elliptical concentrator.

In one aspect, an optic is provided that includes an optical body disposed about an optical axis and having a proximal end and a distal end, the optical body being characterized by an input surface disposed at the proximal end and configured to receive light from a light source, an output surface disposed at the distal end, and a peripheral surface extending at least partially between the input and output surfaces. The input surface forms a cavity for receiving light from at least one light source. The cavity comprises a sidewall ending in an imaging surface disposed about the optical axis. The sidewall couples light into the optical body and to the peripheral surface and the imaging surface couples light into the optical body and to the output surface.

In one embodiment of the above optic, the peripheral surface can include a proximal section disposed opposite the sidewall and a distal section extending along the optical axis between the proximal section and the output surface. In a related aspect, the sidewall can be configured to couple light into the optical body and only to the proximal portion of the peripheral surface. In one aspect, the proximal section of the peripheral surface can present a convex surface to an external environment. In one aspect, the imaging surface presents a convex surface to the at least one light source. In another aspect, the imaging surface provides a refractive surface with a positive optical power to a light source. In some embodiments, the peripheral surface is configured to image at least a portion of the light received through the input surface to the output surface.

In another aspect, an optic is disclosed that includes an imaging portion and a light-redirecting portion. The imaging portion extends between a proximal end and a distal end along an optical axis, and the light redirecting portion is disposed distal to the distal end of the imaging portion. The imaging portion is adapted to receive light at its proximal end from a light source and to form an image of the received light at or close to its distal end. The light-redirecting portion is in turn adapted to receive the imaged light and to redirect that light out of the optic, e.g., in a direction perpendicular to the optical axis and/or in a proximal direction.

In a related aspect, in the above optic, the imaging portion can include an input surface at its proximal end and a peripheral surface that extends from the input surface to the distal end. The input surface can be configured to direct substantially all light that it receives from the light source to the peripheral surface, and the peripheral surface is configured to image (e.g., via total internal reflection) the light it receives onto the distal end, or in proximity to the distal end. In one aspect, the input surface can be configured to direct at least about 80%, at least about 85%, at least about 90%, at least about 95%, or 100% of the light that it receives from the light source to the peripheral surface.

By way of example, the peripheral surface can be ellipsoidal with one focus at or close to the distal end of the imaging portion. In a related aspect, in the above optic, the redirecting portion can include a redirecting surface that is positioned to receive the imaged light (e.g., the image of the light source generated by the imaging portion) and to redirect that light in a direction perpendicular to the optical axis and/or in a proximal direction.

In some embodiments, the redirecting portion includes a lateral surface through which the light redirected by the redirecting surface exits the optic. In one embodiment, the redirecting surface is in the form of an inverted cone and the lateral surface is substantially cylindrical.

In one aspect, a method for designing an optic is provided. The method can include defining an optical body having a proximal end, a distal end, and a peripheral surface extending at least partially therebetween, the optical body being characterized by an input surface at the proximal end and a redirecting element disposed at the distal end. The method can further include configuring the input surface to form a cavity in the optical body for receiving light from at least one light source. The peripheral surface can be configured such that light propagating thereto from the input surface undergoes total internal reflection and is thereby redirected to the redirecting element. The method further includes configuring the redirecting element to form a redirecting surface such that substantially all light received by the redirecting surface from the peripheral surface undergoes total internal reflection and is thereby redirected out of the optical body in a direction perpendicular to the optical axis and/or in a proximal direction at least partially through an output surface of the redirecting element. In one aspect, the peripheral surface can be configured to image at least a portion of the light received through the input surface to a location adjacent the distal end of the optical body.

### BRIEF DESCRIPTION OF THE DRAWINGS

The invention will be more fully understood from the following detailed description taken in conjunction with the accompanying drawings, in which:

FIG. 1 is a side view of an exemplary embodiment of an optical system according to the teachings of the invention;

FIG. 2A is another side view of the optical system of FIG. 1;

FIG. 2B is another side view of the optic of FIG. 1, depicting rays emanating from a light source traversing the optic;

FIG. 3 is a side view of an exemplary optic constructed in accordance with the teachings herein;

FIG. 4 depicts the optic of FIG. 3 enclosed in an exemplary candelabra-style bulb;

FIG. 5 is another side view of the optic of FIG. 1;

FIG. 6A is a side view of a portion of the optic of FIG. 1, schematically depicting the total internal reflection of a plurality of light rays at a peripheral surface of the optic;

FIG. 6B is another side view of the optic of FIG. 1, schematically depicting the path of a plurality of rays through the optic;

FIG. 7 is a side view of another exemplary embodiment of an optical system according to the teachings of the invention;

FIG. 8 is a side view of another exemplary embodiment of an optical system according to the teachings of the invention; and

FIG. 9 is a side view of another exemplary embodiment of an optical system, according to the teachings of the invention.

### DETAILED DESCRIPTION

Throughout this application, the term “e.g.” will be used as an abbreviation of the non-limiting term “for example.” It should be understood that regardless of whether explicitly stated or not, all characteristics of the optics described herein are by way of example only, and not necessarily requirements. All Figures merely depict exemplary embodiments of the invention.

The present application discloses, among other things, optics and lighting systems, and associated methods. The devices and methods disclosed herein can be used with a wide variety of light sources, including light-emitting-diodes and incandescent bulbs, or other coherent or non-coherent sources. Such devices and methods can have a wide range of applications, including, for example, in decorative lighting, customizable/adjustable lighting systems, and household lighting, among others. The devices and methods disclosed herein can be incorporated into lighting fixtures such as candelabras and wall sconces.

In many embodiments, the optics and lighting systems disclosed herein can control source light to a specific location (e.g., they can “image” or optically reposition the light from the source to a different spatial location, e.g., from the source to the center of a candelabra bulb). For example, in some embodiments, the optics and lighting systems can image source light to a distal portion of the optical body. In many cases, scattered or stray light can be minimized, which can be advantageous for the aesthetics of the light.

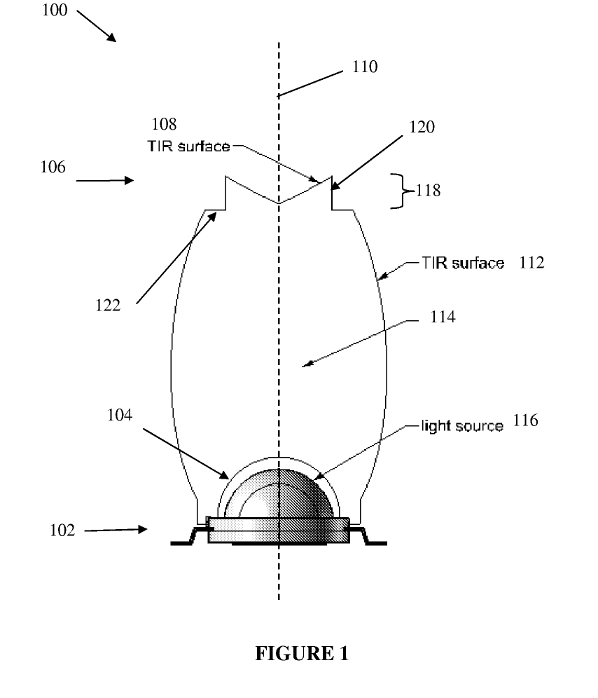

FIG. 1 shows schematically a cross-section of one exemplary embodiment of an optic 100. In this embodiment, an optical body 114 extends along an optical axis 110 between a proximal end 102 and a distal end 106. At the proximal end 102, an input surface 104 forms a recess or cavity for receiving light emitted by a light source 116 and/or the light source 116 itself. A wide variety of light sources can be used, however in this case the light source 116 is a light-emitting diode (LED).

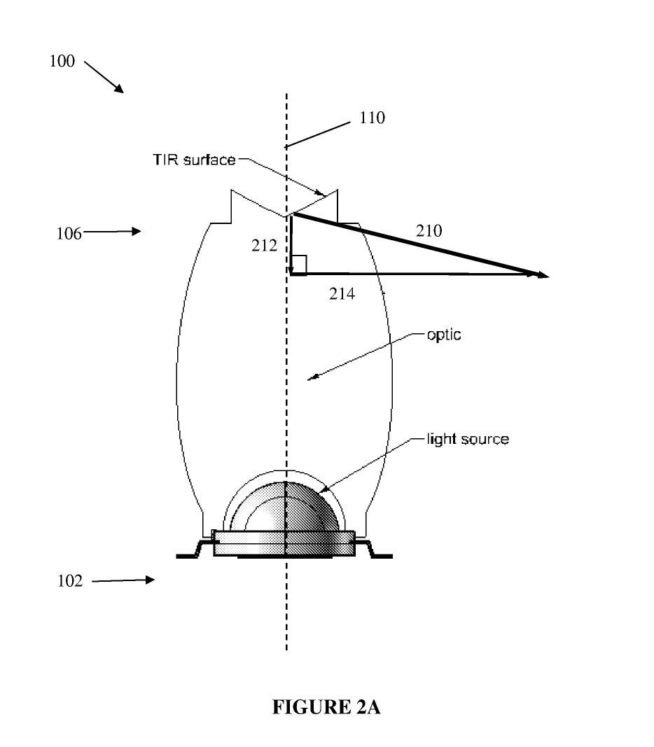

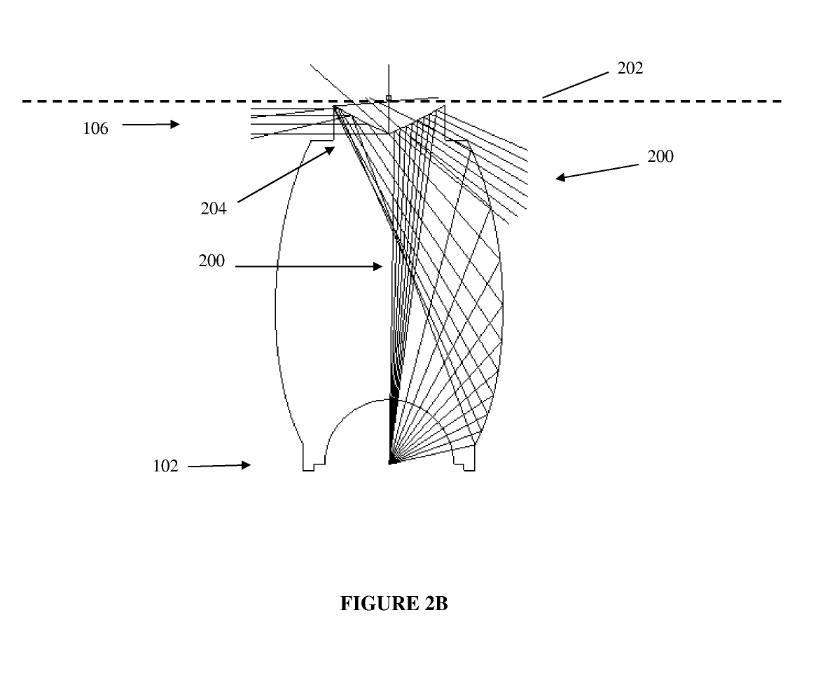

In this exemplary embodiment, the peripheral surface 112 (also referred to herein as a lateral surface) is shaped such that light entering the light source 116 at the input surface 104 and propagating to the peripheral surface 112 undergoes total internal reflection at the peripheral surface 112. The effect of this total internal reflection is shown generally in the exemplary ray tracings of FIG. 2B.

In some cases, at least about 80% (or at least 85%, or at least 90%, or at least 95%, or 100%) of light propagating to the peripheral surface 112 from the input surface 104 undergoes total internal reflection to be redirected to element 118 at the distal end of the optic 100. In other cases, substantially all light propagating to the peripheral surface 112 from the input surface 104 undergoes total internal reflection and is redirected to element 118 at the distal end of the optic 100. As used herein, the phrase “substantially all” light undergoes total internal reflection and is redirected is meant to indicate that all but a small portion of light, immaterial to the purposes for which the optic is employed, undergoes total internal reflection and is so redirected. In some cases, for example, about 90% or more of light can be totally internally reflected, or in other cases about 95% or more, about 98% or more, or about 100%. As one skilled in the art will understand, optic surfaces that are intended to redirect incident light (e.g., via total internal reflection) can be configured, using known techniques, to redirect all light or substantially all light, or any of the above-recited percentages (e.g., in alternate embodiments).

As is known in the art, total internal reflection can occur at an interface between two media having different indices of refraction when the light traversing the medium having the larger index is incident on the interface at an angle relative to a normal to the interface that exceeds a critical angle, which can be defined by the following relation:

$${θ}_{crit} = arc sin \frac{{n}_{2}}{{n}_{1}}$$

where n₁ is the refractive index of the medium having the larger index and n₂ is the refractive index of the medium having the lower refractive index.

In other embodiments, the peripheral surface 112 can be metalized or otherwise configured for specular reflection (e.g., to specularly reflect substantially all light). In either case, the rays incident on the peripheral surface can be redirected (via total internal reflection or specular reflection, or otherwise) to element 118 located at the distal end of the optic.

Element 118 is a redirecting element, also referred to herein as a redirector 118, which can be located at the distal end 106 of the optic and can receive light redirected by the peripheral surface 112, as well as source light that propagates through the optical body 114 directly to the redirecting element 118 without redirection from the peripheral surface 112 (e.g., see exemplary rays 200 in FIG. 2B). In this embodiment, the redirecting element 118 is configured to redirect light in a direction perpendicular to the optical axis and/or in a proximal direction. In various embodiments, the redirecting element can be configured to redirect at least 80 percent of light in such a manner, or in other embodiments substantially all light, or in other embodiments 90 percent or more, 95 percent or more, 98 percent or more, or 100 percent.

As used herein, the term “proximal direction” refers to any direction with a non-zero component along the optical axis and pointed towards the proximal end (e.g., proximal end 102). An example of a vector 210 having a non-zero component along the optical axis and pointed towards the proximal end (component 212) is illustrated in FIG. 2A. A component 214 of vector 210 that is perpendicular to the optical axis is also shown in FIG. 2A.

In some embodiments, the redirecting element 118 can be configured to redirect light (e.g., any of the amounts/percentages recited above) to a region proximal to a horizon plane 202. As used herein, the term “horizon plane” refers to a plane that is orthogonal to the optical axis and that is disposed at or near the distal end 106 and external to the optic 100. In other words, a horizon plane is oriented such that the optical axis represents a normal vector to the horizon plane, with the horizon plane being disposed external to the optic and at or near its distal end. An exemplary illustration of a horizon plane is shown in FIG. 2B, which, it should be noted for clarity, presents a view of the edge of an exemplary horizon plane 202, which in three-dimensions would run into and out of the page. In the orientation of FIG. 2B, the term “proximal to” refers to the region “below” the plane 202, as end 102 represents the proximal end 102 of the optic 100. Rays that are directed to a region proximal to a horizon plane can include, in many cases, rays directed parallel to a horizon plane.

It should be understood that, even if not explicitly stated, any description herein referring to redirecting light (e.g., by a surface, using total internal reflection or otherwise) perpendicular to the optical axis and/or in a proximal direction can also be implemented in alternative embodiments so as to redirect light such that it propagates to a region proximal to a horizon plane.

In FIG. 1, the redirecting element 118 includes redirecting surface 108 disposed about the optical axis 110. In many embodiments, the redirecting surface 108 can present a concave surface to the external environment and/or can be shaped like an inverted cone, with a vertex located on the optical axis 110 (that is, the surface 108 can be shaped to form a cavity that has the shape of a cone, the optical body 114 defining the exterior of the cone along the surface 108). In this case, the surface 108 is configured as a total internal reflection surface for redirecting light incident thereon from the peripheral surface 112 out of the optic and in a direction perpendicular to the optical axis, as shown for example by rays 204 in FIG. 2B. Further, in this case, the surface 108 is configured to redirect, via total internal reflection, light propagating thereto directly from the input surface 104 out of the optic in a proximal direction, as shown for example by rays 200 in FIG. 2B). As those skilled in the art will understand, the surface 108 can be configured to redirect any of the amounts/percentages of light recited above (e.g., 80 percent or more, 90 percent or more, etc.) in such ways.

In some embodiments, the surface 108 can be configured as a total internal reflection surface for redirecting light incident thereon from the peripheral surface 112 out of the optic and to a region proximal to a horizon plane. The surface 108 can also be configured to redirect, via total internal reflection, light propagating thereto directly from the input surface 104 out of the optic and to a region proximal to that horizon plane. Again, as those skilled in the art will understand, the surface 108 can be configured to redirect any of the amounts/percentages of light recited above (e.g., 80 percent or more, 90 percent or more, etc.) in such ways.

In some embodiments, the surface 108 can be configured to refract a small portion (e.g., 10 percent, or 5 percent or less) of light incident thereon so as to allow that light to exit the optic through that surface 108.

The redirecting surface 108 can be configured to redirect light out of the optical body 114 and to the external environment via the output surface 120, via the peripheral surface 112, through both (as shown in FIG. 2B), or otherwise. The light can undergo refraction as it leaves the optical body 114 at these surfaces. (It should be understood, in view of the foregoing, that in some embodiments the output surface 120 need not be the only surface from which light exits the optical body 114.)

In some embodiments, the redirecting surface 108 can be configured for specular reflection, e.g., via metallization, as an alternative to total internal reflection.

As will be appreciated by the person skilled in the art, the redirecting element 118 can be unitary with the remainder of the optic, or can be a separate portion that is adhered, coupled, or otherwise attached to the rest of the optic.

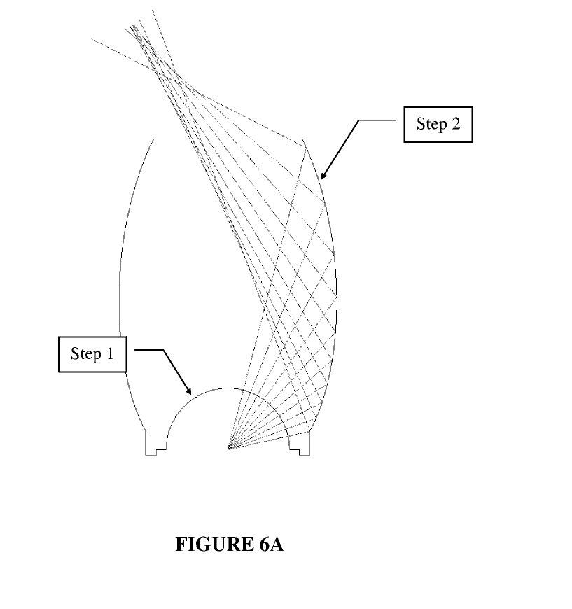

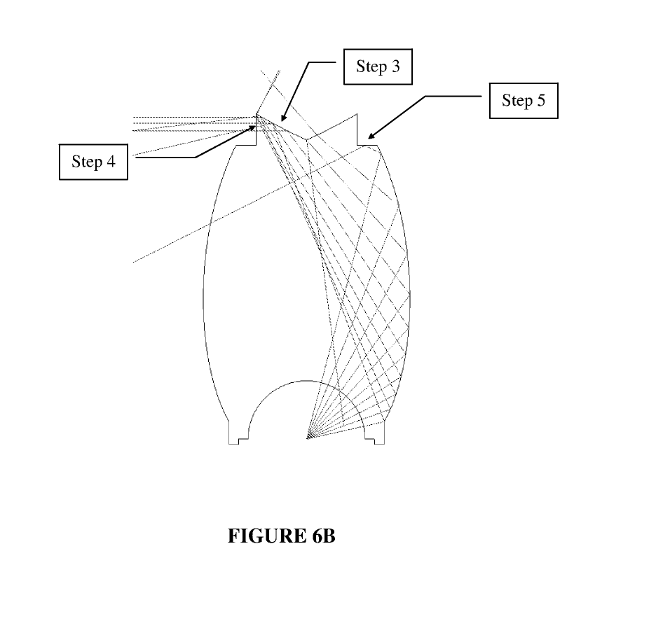

The optic 100 shown in FIG. 1 also includes an output annulus 122 formed at the base of the redirecting element 118. The output annulus 122 can receive light directly from the input surface 104 (e.g., source light that is refracted at the input surface 104 and propagates directly thereto, without redirection at the peripheral surface 112). That incident light can be refracted at the output annulus 122 and exit the optic body 114. In some embodiments, the output annulus 122 can receive some light reflected from the peripheral surface 112 and can couple that light out of the optic body 114 (e.g., via refraction). The output annulus can also be configured to receive light from the peripheral surface and to redirect that light via total internal reflection out of the optic, e.g., in a direction perpendicular to the optical axis and/or in a proximal direction, as shown with exemplary ray tracing in FIG. 6B (“Step 5”).

In many embodiments, the peripheral surface 112 has a curved shape, presenting a convex surface to the exterior environment. In some embodiments, the peripheral surface 112 can be ellipsoidal. The optical body 114, minus the redirecting element 118, can be characterized as a compound elliptical concentrator. The compound elliptical concentrator can be configured to optically reposition the light from the light source to another focal point, which in some embodiments can be off axis (e.g., if the ellipsoidal surface 112 is constructed such that the optical axis of the optic does not coincide with the elliptical axis of the surface 112)—as shown in FIG. 6A, for example. In some embodiments, the surface 112 can be elliptical with the elliptical axis coinciding with the optical axis, one focal point located at the light source and another focal point located on the optical axis, e.g., at the redirecting element 118.

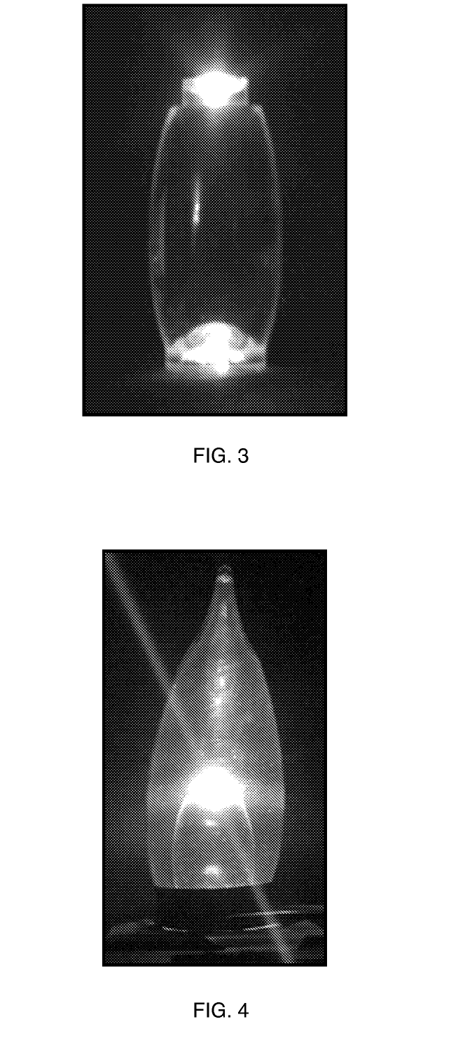

FIG. 3 illustrates an exemplary optic constructed in accordance with the foregoing principles and demonstrates the lit appearance of the optic 100. As can be seen in FIG. 3, light from a light source (a white LED, in this case) has been repositioned to the redirecting element at the distal end of the optic, which redirects the light laterally out of the optic.

FIG. 4 illustrates the optic shown in FIG. 3 enclosed in an exemplary candelabra-style bulb.

In many embodiments, an optic implemented in accordance with the foregoing principles (e.g., as shown in FIGS. 1-4) can be configured to direct substantially all light, or in other cases, at least about 80 percent of light (or at least 85%, at least 90%, at least 95%, or 100%), that is incident on the input surface 104 to the external environment in a direction perpendicular to the optical axis and/or in a proximal direction. In other embodiments, the optic can couple at least about 80 percent (or at least 85%, at least 90%, at least 95%, or 100%) of that light to a region proximal to a horizon plane.

An exemplary process for designing or creating an optic is also disclosed herein. For illustrative purposes, the following description will make reference to the optic surfaces described in connection with FIGS. 1-2B. However, it should be understood that the following description is by way of example only and should not be taken to mean that any of the optics disclosed herein must be designed by such principles or that they must achieve certain results.

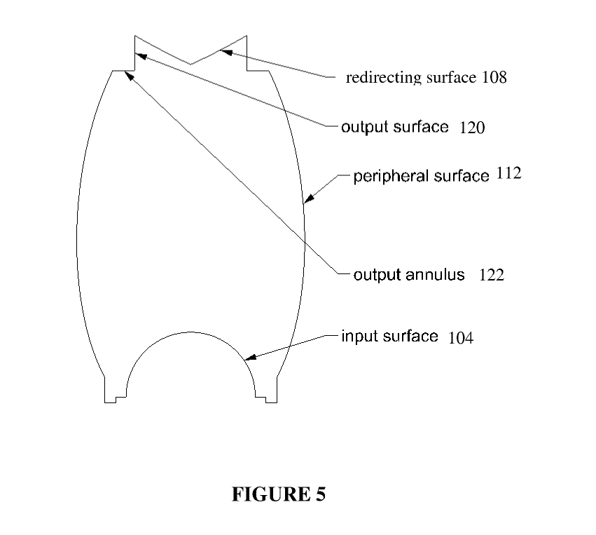

In one embodiment of a design process, a variety of considerations and/or design constraints can be imposed for the surfaces described above that define the optic, as shown in FIGS. 5, 6A and 6B.

For example, in one step, the input surface 104 can be shaped to minimize surface reflection loss, and in many cases, the input surface can be concentric to the light source, e.g., forming a concentric surface surrounding the light source, as shown in FIG. 6A (“Step 1”). (It should be understood that the numbering of steps (step 1, step 2, etc.) in FIGS. 6A and 6B is merely for reference purposes and do not necessarily indicate a particular order of steps or that all steps must be performed.) In some cases, the curvature of the input surface 104 can be shaped to match or approximate the light source surface, e.g., the bulb, lens, the LED package, or the LED epoxy seal.

The peripheral surface 112 can be designed to effect total internal reflection to redirect source light incident thereon (e.g., substantially all source light incident thereon) to the redirection surface 108, as shown in “Step 2” of FIG. 6A. As FIG. 6A shows, the redirected rays can converge to a focal point (assuming, for example, that no redirecting surface is present at the distal end of the optic).

The redirecting surface 108 can be configured as a total internal reflection surface to redirect light (e.g., substantially all light) from the peripheral surface to the output surface 120, as shown in “Step 3” in FIG. 6B.

In other embodiments, the redirecting surface 108 can also be configured as a total internal reflection surface to redirect light coming directly from the input surface 104 out of the optic 100, e.g., through the peripheral surface 112 or the output surface 120, or both.

The output surface 120 can be designed to be flat or curved to provide a desired lit appearance, as shown in “Step 4” in FIG. 6B. The output surface can also have surface features formed thereon, including, for example, surface texturing, microlenses, microprisms, lenslets, microcylinders, and so on.

The output annulus 122 can be configured to redirect, via total internal reflection, light received from the peripheral surface 112 out of the optic, e.g., via the peripheral surface 112, as shown in “Step 5” in FIG. 6B. The output annulus 122 can also be configured to refract light that it receives directly from the input surface 104. The output annulus 122 can be flat or curved or can have surface features formed thereon for appearance purposes, e.g., to spread or diffuse the light.

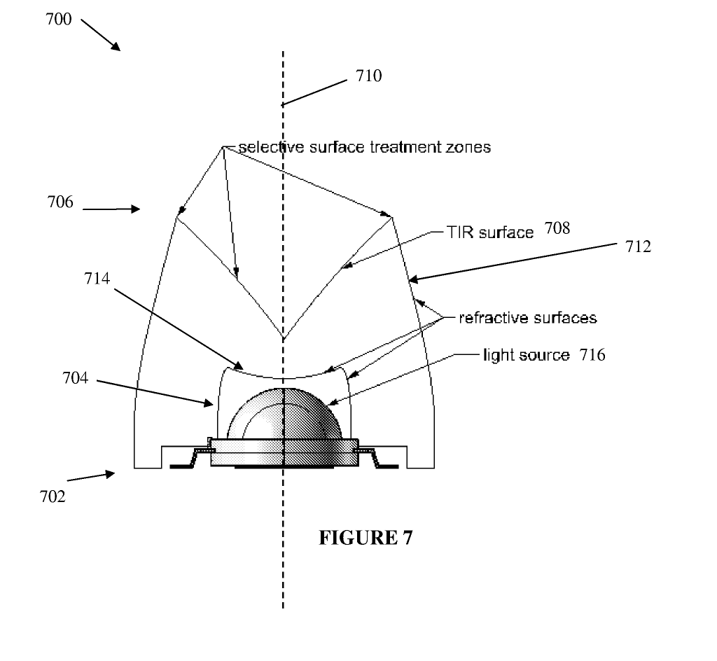

FIG. 7 shows schematically a cross-sectional view of another embodiment of an optic 700. In this embodiment, an optic 700 has a body disposed about an optical axis 710 and defined by an anterior surface forming a recess (collectively, surfaces 704 and 714) at a proximal end 702 and a posterior surface 708 at a distal end 706. A peripheral surface 712 extends between the proximal and distal ends 702, 706. The recess is defined, in this case, by a sidewall 704 which ends in a distal wall 714, which in FIG. 7 is illustrated as presenting a convex surface to the light source 716. The sidewall 704 and distal wall 714 of the recess can be configured to receive and refract light from the light source 716. Light refracted at the sidewall 704 can be directed to peripheral surface 712, where it can undergo refraction and exit the optic 700. Light refracted at the distal wall 714 can be directed to the posterior surface 708, which can be configured as a total internal reflection surface, e.g., to cause that light received from the recess to undergo total internal reflection and to be thereby redirected to the peripheral surface 712, where it exits the optic 700. In some cases, the posterior surface 708 can be configured to cause at least about 80 percent of light incident thereon to undergo total internal reflection and to be thereby redirected to the peripheral surface 712, and in other cases it can be configured to cause substantially all light incident thereon to undergo total internal reflection and to be thereby redirected to the peripheral surface 712.

In many cases, the posterior surface 708 can be shaped to present a concave surface to the external environment, and in some cases can be in the form of a negative conic surface with a vertex on the axis 710. The posterior surface can be provided with a plurality of surface treatment zones to control light exiting the posterior surface (e.g., that light not being totally internally reflected), which can have an advantageous decorative effect. Such surface treatment zones can include, without limitation, surface texturing, microlenses, microprisms, lenslets, microcylinders, and so on.

In many embodiments, substantially all light, or in other cases at least about 80 percent of light (or at least 85%, at least 90%, at least 95%, or 100%), that is incident on the input surface can be coupled, via the optic 700, to the external environment in a direction perpendicular to the optical axis and/or in a proximal direction.

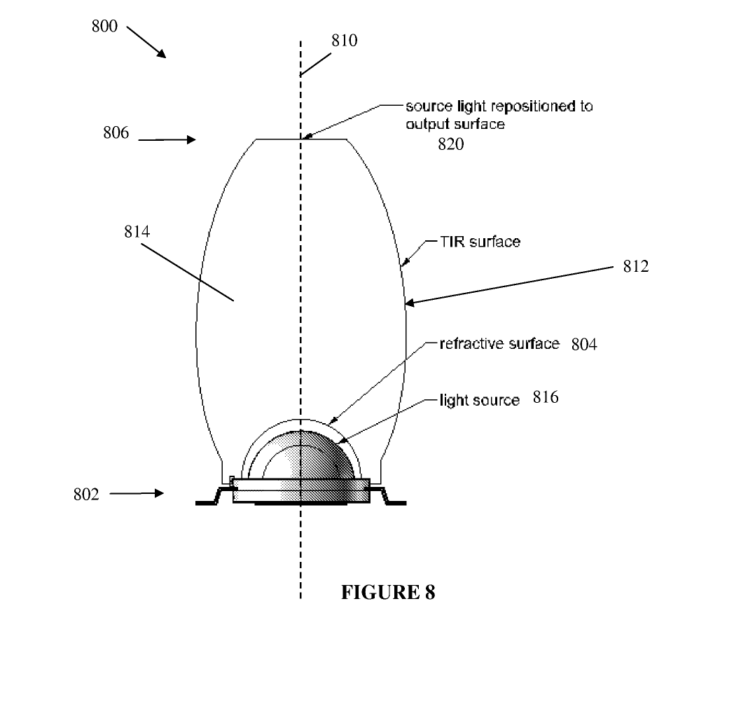

FIG. 8 shows a cross-sectional view of another embodiment of an optic 800 which can be configured similarly, in many respects, to the optic 100 shown in FIG. 1. In this embodiment, the optic 800 includes an optical body 814 disposed about an optical axis 810 and extends between proximal and distal ends 802, 806. In this embodiment, an input surface 804 is located at the proximal end 802 and output surface is located at the distal end 806, with a peripheral surface 812 extending therebetween. Unlike the optic 100 shown in FIG. 1, in this embodiment the optic 800 does not include a redirecting element at the distal end 806 thereof.

The peripheral surface 812 can be configured to totally internally reflect light received from the input surface to the output surface. The peripheral surface 812 can be elliptical. In such a case, the light source 816 can be positioned at or near one focal point of the ellipse defined by the peripheral surface and the output surface can be positioned at the other, which can have the effect of repositioning (e.g., re-imaging) the light source to the output surface 820.

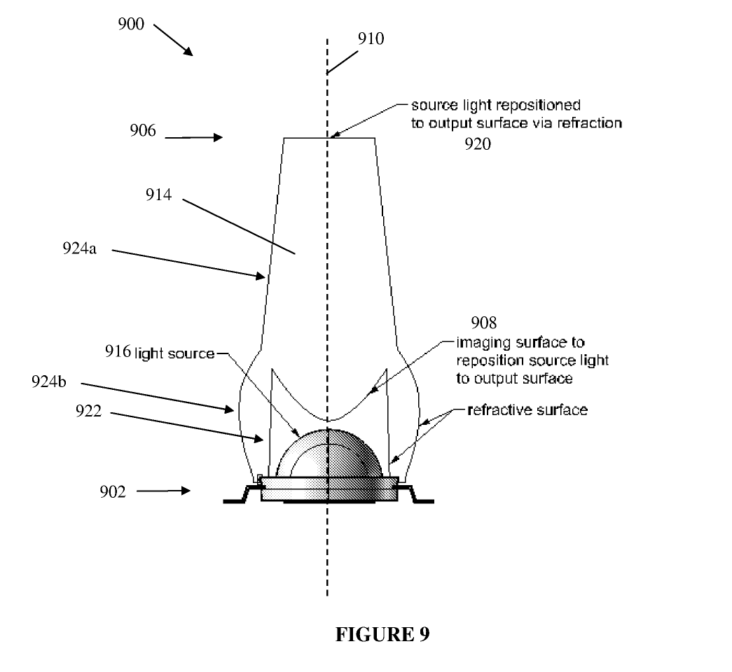

FIG. 9 shows a cross-sectional view of another embodiment of an optic 900. The optic 900 can include an optical body 914 disposed about an optical axis 910. An input surface at a proximal end 902 of the body can receive light from a light source 916. In this case, the input surface forms a recess or cavity defined by a sidewall 922 ending in a distal imaging surface 908, which in this case presents a convex surface to the light source 916 and provides a positive optical power for converging light incident thereon from the light source 916. The imaging surface 908 can be configured to refract light such that the source light is repositioned (e.g., reimaged), via refraction, at the output surface 920, which is located at the distal end 906 of the optic 900. In many cases, the output surface 920 can be located at a focal point of the imaging surface 908.

The sidewall 922 can be configured to couple light (e.g., via refraction) to a proximal section 924b of the peripheral surface 924 (which in this embodiment is composed of proximal section 924b and distal section 924a). The proximal section 924b can be disposed generally opposite the sidewall 922 and can be adapted to refract light received therefrom as it exits the optical body 914. In this embodiment, the proximal section 924b presents a convex surface to the external environment. The distal section 924a can act as a light pipe (e.g., of a length equal to a focal length of the imaging surface 908, in many embodiments) in which light can propagate from the imaging surface to the output surface.

It should be noted that in the exemplary embodiments disclosed herein the optics are illustrated and described herein in terms of two-dimensional cross-sections which can be extended, e.g., rotationally, in space to create a three-dimensional device. Typically a symmetric three-dimensional extension, e.g., rotationally symmetric about the optical axis, can be employed, however the teachings herein can be applied to non-symmetric revolutions as well, e.g., in the case of an oval, parabola, and so on. In addition, the optics described herein can be linearly extended, for example in order to create a rectangular optic.

Any of the optics described above can be hollow or solid and made of polymethyl methacrylate (PMMA), glass, polycarbonate, cyclic olefin copolymer and cyclic olefin polymer, or any other suitable material. By way of example, a lens can be formed by injection molding, by mechanically cutting a reflector or lens from a block of source material and/or polishing it, by forming a sheet of metal over a spinning mandrel, by pressing a sheet of metal between tooling die representing the final surface geometry including any local facet detail, and so on. Reflective surfaces can be created by a vacuum metallization process which deposits a reflective metallic (e.g., aluminum) coating, by using highly reflective metal substrates via spinning or forming processes. Faceting on reflective surfaces can be created by injection molding, by mechanically cutting a reflector or lens from a block of source material and/or polishing it, by pressing a sheet of metal between tooling die representing the final surface geometry including any local facet detail, and so on.

Any publications or patent applications referred to herein, as well the appended claims, are incorporated by reference herein and are considered to represent part of the disclosure and detailed description of this patent application. Moreover, it should be understood that the features illustrated or described in connection with any exemplary embodiment may be combined with the features of any other embodiments. Such modifications and variations are intended to be within the scope of the present patent application.

What is claimed is:

1. An optic, comprising:
an optical body disposed about an optical axis and having a proximal and distal ends, the optical body being characterized by an input surface disposed at the proximal end and configured to receive light from a light source, a redirecting element disposed at the distal end, and a peripheral surface extending at least partially between the proximal and the distal ends,
said input surface forming a cavity for receiving light from at least one light source, and said peripheral surface being configured such that light propagating thereto from the input surface undergoes total internal reflection and is thereby redirected to the redirecting element,
wherein the redirecting element includes:
an output surface, and
a redirecting surface configured such that substantially all light that received by the redirecting surface from the peripheral surface undergoes total internal reflection and is thereby redirected out of the optical body at least partially through the output surface and perpendicular to the optical axis and/or in a proximal direction.

2. The optic of claim 1, wherein the peripheral surface is configured to image at least a portion of the light received through the input surface to a location adjacent the distal end of the optical body.

3. The optic of claim 1, wherein the redirecting surface is disposed about the optical axis.

4. The optic of claim 3, wherein the redirecting surface is symmetric about the optical axis.

5. The optic of claim 1, wherein the redirecting surface is configured such that at least about 95 percent of light received by the redirecting surface from the peripheral surface undergoes total internal reflection and is thereby redirected out of the optical body at least partially through the output surface and perpendicular to the optical axis and/or in a proximal direction.

6. The optic of claim 1, wherein the redirecting surface is configured such that substantially all light propagating thereto directly from the input surface undergoes total internal reflection and is thereby redirected out of the optical body at least partially through the output surface and perpendicular to the optical axis and/or in a proximal direction.

7. The optic of claim 6, wherein the redirecting surface is configured such that at least about 95 percent of light propagating thereto directly from the input surface undergoes total internal reflection and is thereby redirected out of the optical body at least partially through the output surface and perpendicular to the optical axis and/or in a proximal direction.

8. The optic of claim 1, wherein the redirecting surface is configured to redirect light, via total internal reflection, out of the optical body through the output surface and the peripheral surface to a region proximal to a plane orthogonal to the optical axis and disposed at or near the distal end of the optical body and external thereto (“horizon plane”).

9. The optic of claim 1, wherein the peripheral surface is ellipsoidal.

10. The optic of claim 1, wherein the output surface is disposed substantially parallel to the optical axis.

11. The optic of claim 1, wherein the output surface extends from a distal end to a proximal end and is cylindrical.

12. The optic of claim 11, wherein the redirecting element is concave.

13. The optic of claim 11, wherein the cylinder has a central axis extending along the optical axis.

14. The optic of claim 1, further comprising an output annulus extending between the output surface and the peripheral surface, the output annulus being configured to redirect, via total internal reflection, light incident thereon and propagating from the peripheral surface.

15. The optic of claim 14, wherein the output annulus is disposed substantially orthogonal to the optical axis.

16. An optic, comprising:
an optical body disposed about an optical axis and having a proximal and distal ends, the optical body being characterized by an input surface disposed at the proximal end and configured to receive light from a light source, a redirecting element disposed at the distal end, and a peripheral surface extending at least partway between the proximal and the distal ends,
said input surface forming a cavity for receiving light from at least one light source, and said peripheral surface being configured such that light propagating thereto from the input surface undergoes total internal reflection and is thereby redirected to the redirecting element,
wherein the redirecting element includes:
an output surface;
a redirecting surface disposed about the optical axis, the redirecting surface being configured such that substantially all light received from the peripheral surface undergoes total internal reflection and is thereby redirected out of the optical body at least partially through the output surface and to a region proximal to a plane orthogonal to the optical axis and disposed at or near the distal end of the optical body and external thereto (“horizon plane”).

17. The optic of claim 16, wherein the peripheral surface is configured to image at least a portion of the light received through the input surface to a location adjacent the distal end of the optical body.

18. The optic of claim 16, wherein the redirecting surface is configured such that substantially all light propagating thereto directly from the input surface undergoes total internal reflection and is thereby redirected out of the optical body and to a region proximal to the horizon plane.

19. The optic of claim 16, wherein the redirecting surface is configured to redirect light, via total internal reflection, to a region proximal to the horizon plane and out of the optical body through one or more of the output surface and the peripheral surface.

20. An optic, comprising:
a compound elliptical concentrator extending along an optical axis between proximal and distal ends, the compound elliptical concentrator being configured to receive light from a light source at the proximal end and to output that light at the distal end,
a redirecting element optically coupled to the compound elliptical concentrator and including an output surface extending from the compound elliptical concentrator to a redirecting surface disposed about the optical axis, the redirecting surface being configured such that substantially all light propagating thereto from the compound elliptical concentrator undergoes total internal reflection and is thereby redirected perpendicular to the optical axis and/or in a proximal direction, and out of the optical body.

21. The optic of claim 20, wherein the compound elliptical concentrator comprises a solid optical body with an elliptical peripheral surface configured such that light propagating thereto from the proximal end undergoes total internal reflection and is thereby redirected to the redirecting element.

22. The optic of claim 20, wherein the compound elliptical concentrator is configured to image at least a portion of the light received from the light source at the proximal end to a location adjacent the distal end of the compound elliptical concentrator.
